(19) United States
(12) Patent Application Publication
(10) Pub. No.: US 2013/0314812 A1
(43) Pub. Date: Nov. 28, 2013

(54) MIRROR CONSTRUCTION FOR CONCENTRATED SOLAR SYSTEMS BY FRC AND APPLICATIONS

(71) Applicant: George Philip Tharisayi, Berkeley, CA (US)

(72) Inventor: George Philip Tharisayi, Berkeley, CA (US)

(21) Appl. No.: 13/845,788

(22) Filed: Mar. 18, 2013

Related U.S. Application Data
(60) Provisional application No. 61/688,897, filed on May 24, 2012.

(51) Int. Cl. G02B 19/00

(52) U.S. Cl. CPC G02B 19/0042
USPC 359/853; 264/279

(57) ABSTRACT

A building integrated solar mirror for use in a concentrated solar power (CSP) and concentrated photovoltaic (CPV) apparatus comprising a casing filled with fiber reinforced concrete having a reflective film attached to the concave curvature of the said casing, a process for its manufacture and use. The solar mirror characterized in that it forms an integral part of a building and can serve as roof or wall of the building, thus reducing the overall cost of transportation and installation of the said solar mirrors in CSP and CPV systems and also saving the enormous land required for the installation of these systems.

### FIELD OF THE INVENTION

The invention relates to solar mirror, especially a building integrated solar mirror made of fiber reinforced concrete (FRC) or glass fiber reinforced concrete or a combination thereof for use in a concentrated solar systems and the process for its manufacture and use.

### BACKGROUND OF THE INVENTION

Concentrated solar power system (CSP) and concentrated photovoltaic systems (CPV) provide an efficient means of utilizing the non-conventional energy resources but they are capital intensive and therefore not currently widely deployed. The successful commercialization of solar thermal energy largely depends upon developing a system that provides energy at a cost low enough to be competitive with energy from conventional fuels.

Recent studies have shown that the majority of cost for a CPV or CSP system is represented by the concentrator (i.e mirrors).Another factor contributing to cost of these systems is their requirement for fair amount of land for their installation

Currently, concentrating solar power devices have solar mirrors which are composed of a plurality of mirror-finished plates which are curved so as to provide a semi cylindrical-parabolic surface which is adapted to reflect the rays of the sun, concentrating them on the collector tube arranged at the rectilinear focal line of such surface. Such plates are generally made of glass and are rendered reflective by silvering. Such plates are then generally glued to a series of supporting panels, which are fastened to the supporting frame, which is intended to support and orient the solar mirror obtained by arranging the panels mutually adjacent.

The use of such mirror-finished plates has the drawback that the process for forming them according to the desired curvature is complicated and expensive.

Several efforts have been made to make concentrated solar systems cost effective. EP Patent No. 1918661A1 proposes a building element with integrated solar heating element which can be used either as roof or façade of the building, the building element being made up of multi-wall polycarbonate panels. However the high cost of polycarbonate panels and their manufacturing process which is not very environmental friendly do not make them an idle candidate to be used in solar heating elements. U.S. Pat. No. 4,515,151 describes a solar collector made up of fiber reinforced concrete (FRC).

Fiber reinforced concrete (FRC) has high durability and strength but also is more economical than commercially used and expensive steel trusses. This reduces the cost of CSP and CPV systems to some extent nevertheless the incurring cost involved in the transportation and installation of CSP and CPV apparatus and a considerable land usage by these systems still contribute a substantial amount to the cost of these systems.

### OBJECT OF THE INVENTION

It is therefore an object of the invention to develop a solar mirror which forms an integral part of a building and is capable of being used to reflect solar light to be used by concentrating solar power (CSP) and concentrated photovoltaic (CPV) systems. The roof or wall of the building is so designed and constructed mainly applying fiber reinforced concrete (FRC) or glass fiber reinforced concrete (GFRC)., the said roof or wall is directly capable of acting as the component of CSP and/or CPV systems. This reduces the overall cost of transportation and installation of these solar mirrors in CSP and CPV systems and also takes into consideration the enormous land requirement by these systems. Moreover the solar mirror should be cost effective and also have a long service life.

### SUMMARY OF THE INVENTION

This problem is solved by the invention by developing a solar mirror which forms an integral part of the building structure and can thus serve as roof or wall of the building. This in turn saves the land required by the CSP and CPV systems and also reduces overall cost of transportation and installation of these systems

Another object of the invention is to provide a method for batch and bulk manufacturing of the said building integrated solar mirror

Yet another objective of the invention is to develop the said building integrated solar mirror using fiber reinforced concrete which provides a solar mirror that is cost effective, durable and have a long service life

Still another object of the invention is to provide a method for manufacturing of the said building integrated solar mirrors of parabolic trough, dish or fresnel type

Yet another object of this invention is the application of the said building integrated solar mirrors as fixed roof or wall of commercial buildings, structures, tanks and houses. Also the said mirror when installed horizontally will have a small slope to facilitate drainage of rain water or for any washing liquid or water applied.

These and other objects of the invention will become apparent in the study of the description of the invention and drawings which follows.

### BRIEF DESCRIPTION OF DRAWINGS

FIG. 1 is a cross sectional view of a solar trough mirror (14) shown in FIG. 3 and of a dish mirror (15) shown in FIG. 4 and FIG. 5

FIG. 2 shows an enlarged sectional view of a portion of a trough mirror (14) shown in FIG. 3 and of a dish shaped mirror (15) shown in FIG. 4 and FIG. 5.

FIG. 3 is an isometric view of the trough mirror (14) according to the invention,

FIG. 4 shows a plain view of a dish mirror (15) with a receiver (10), injection ports (11) and residual air vent port (11) and (12) is a drain.

FIG. 5 is the sectional view of the dish mirror (15)

FIG. 6 is the isometric view of a plurality of trough mirrors (14) shown in FIG. 3 placed side by side which is used as roof or wall of the building.

FIG. 7 is the side view of the dish mirror (15) when used as roof of a tank or other structure

### DESCRIPTION OF THE PREFERRED EMBODIMENTS

The aim of the current invention is to construct solar mirrors using modern fiber reinforced concrete (WC) or glass fiber reinforced concrete (GFRC) or a combination thereof instead of considerably more expensive steel trusses that are typically used. Such minors form an integral part of the building or structure and when assembled contiguously can constitute the roof or wall of the building. Such fixed mirror roof will cost less than the cost of a typical roof mounted with CSP and CPV systems.

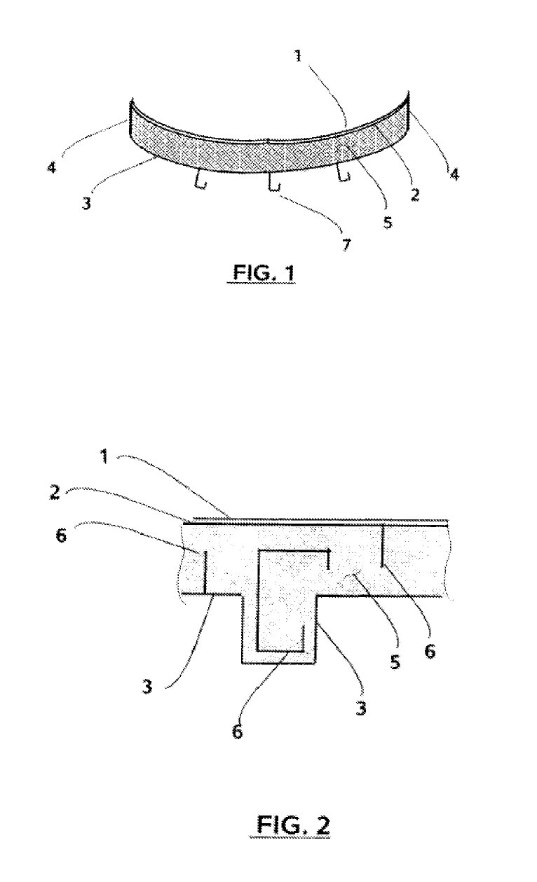

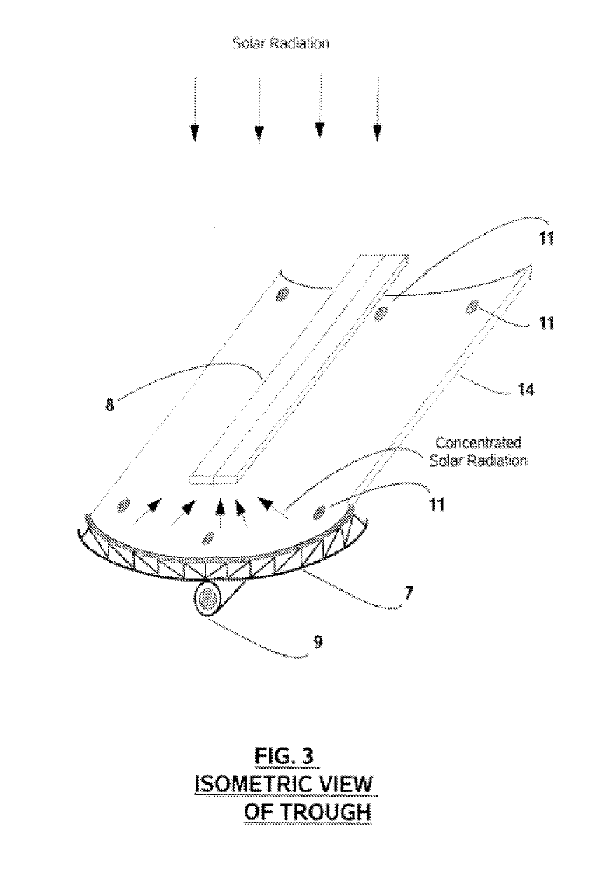

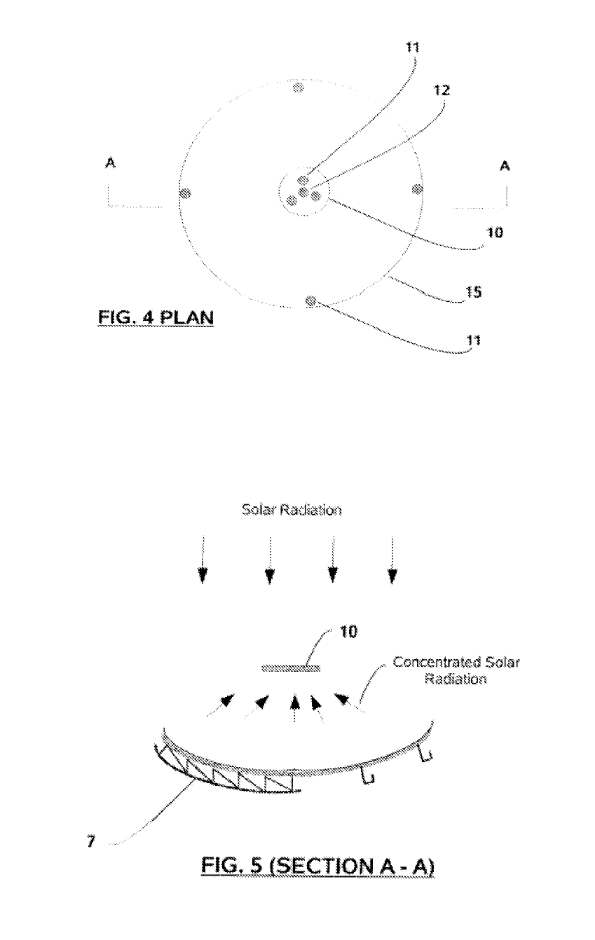

FIG. 1 shows a cross sectional view of a solar trough mirror (14) shown in FIG. 3 and of a dish mirror (15) shown in FIG. 4 and FIG. 5. Solar concentrating mirrors like trough, dish or fresnel can be manufactured from fiber reinforced concrete (FRC) or glass fiber reinforced concrete (GFRC). The trough mirror (14) shown in FIG. 3 consists of casing top (2), casing bottom (3), casing sides (4) and structural reinforcements (6). FRC or GFRC is injected through one or more injection ports (11) and residual air is vented out through one or more ports (11). After FRC or GFRC or a combination thereof is set or nearly set, the top (concave) side of the casing top (2) is smoothed, after any refilling of FRC as necessary a reflective film (1) is applied to the top (concave) side (2) with an epoxy or other glue to form a solar mirror.

FIG. 2 shows an enlarged sectional view of a portion of a trough mirror (14) shown in FIG. 3 and of a dish shaped mirror (15) shown in FIG. 4 and FIG. 5. (5) is FRC or GFRC or a combination thereof. Reinforcements (6) are positioned longitudinally or transversely and may be made from plastic, fiber reinforced plastic (FRP) or a metal. Reinforcing fibers are often made from glass but can also be made from plastic, metal or graphite. The solar radiation is reflected and concentrated onto a Photovoltaic (PV) cell or a thermal collector as shown in FIG. 3, FIG. 4 and FIG. 5.

Referring to FIG. 3, which is an isometric view of the trough (14), (7) is one or a plurality of truss or trusses distributed along the axis or transversely of the trough mirror. (8) is a receiver consisting of a photovoltaic (PV) cell with a cooling mechanism or a thermal collector. (9) is a tracking mechanism supporting the trough mirror (14). The trough and dish mirrors can utilize support and tracking systems from all available support and tracking systems

FIG. 4 shows a plain view of a dish mirror (15) with a receiver (10) consisting of photovoltaic (PV) cell or a thermal collector or both. (11) are ports generally placed on top (concave side) and used as injection port or as air vent port and (12) is a drain.

The dish mirror (15) shown in FIG. 4 and FIG. 5, the cross section of which is shown in FIG. 1 and FIG. 2, consists of consists of casing top (2), casing bottom (3), casing sides (4) and reinforcements (6). FRC or GFRC is injected through one or more injection ports (11) and residual air is vented out through one or more ports (11). After FRC or GFRC or a combination thereof is set or nearly set, the top (concave) side of the casing top (2) is smoothed, after any refilling of FRC as necessary a reflective film (1) is applied to the top (concave) side (2) with an epoxy or other glue to form a solar mirror.

The solar radiation is reflected and concentrated onto a receiver (8) i.e a Photovoltaic (PV) cell with a cooling mechanism or a thermal collector as shown in FIG. 3, FIG. 4 and FIG. 5. A Photovoltaic (PV) cell or a thermal collector is selected from all available sources.

FRC retains its shape during setting and has better strength and is more economical in many applications It is believed that utilizing concrete and FRC with reinforcements made from fiber reinforced plastic (FRP) and metal fibers and injected into a casing as described in here will not only result in lower construction cost for solar mirrors but will also improve their strength, reliability and longevity. It is believed that this system can be used for batch or bulk manufacturing of solar mirrors

It is well known that lower mirror cost will result in lower cost for solar power in installed cost and in kilowatt hours produced by concentrated solar systems and for thermal systems. It is believed that lower mirror cost will also result in lower cost for heat, measured in Btu or in other heat units in direct utilization systems including absorption chillers and air conditioning.

This technique is ideal for fixed or sun tracking mirrors. When the trough or dish mirrors are fixed being part of a building or structure or when fixed but not as part of a structure, the sun tracking is accomplished by moving the receiver (8).

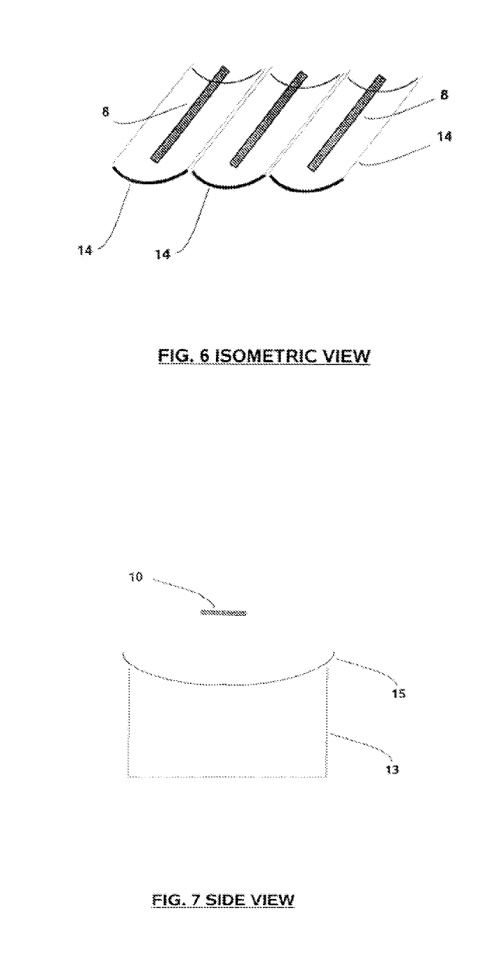

FIG. 6 shows an isometric view of a plurality of trough mirrors (14) shown in FIG. 3 placed side by side. (8) represent receiver or receivers consisting of one or more photovoltaic (PV) cells with a cooling mechanism or a thermal collector which are either fixed or moving singularly or in unison, for tracking the sun as needed. The trough mirrors have application as a fixed mirror to serve as roof or as wall of commercial buildings, structures and houses when placed side by side as shown in FIG. 6.

The dish mirrors have application as a fixed mirror to serve as roof or wall of commercial buildings tanks and structures as shown in FIG. 7, with moving receiver (10) for sun tracking The fixed trough mirrors or mirrors placed side by side as shown in FIG. 6 when serving as the roof or as wall of commercial buildings, structures and houses become integral part of the building and can be load bearing in order to economize the building with solar systems. The trough mirrors when placed side by side a suitable gap or no gap can be left between trough mirrors. The trough and dish mirrors have application as a sun tracking mirror to serve as the concentrator for photovoltaic (PV) and thermal applications. The trough and dish mirror cross section can be parabolic or form a circular arc or of any shape similar to these. The trough or dish mirrors when installed horizontally will have a small slope to facilitate drainage of rain water or for any washing liquid or water applied.

1) A solar mirror for use in concentrated solar systems, the said mirror made up of fiber reinforced concrete (FRC), glass fiber reinforced concrete (GFRC) or a combination thereof, wherein the said mirror comprises of a top concave light reflecting smooth surface, the said mirror is characterized in that a plurality of the said mirrors when assembled contiguously in a desired area constitute the roof or wall of a building or similar structure.

2) The solar mirror for use in concentrated solar systems as claimed in claim 1, wherein the said top concave light reflecting smooth surface of the said mirror preferably comprises of a reflective film attached to the top concave curvature of the said mirror.

3) The solar mirror for use in concentrated solar systems as claimed in claim 1, wherein the mirror is fixed, the receiver is moving and tracking the sun and the receiver is mounted along the focal line of the said mirror.

4) A process for making the mirror as claimed in claim 1, wherein the said solar mirror is made by the process comprising the steps of:
a) Making a casing of desired shape with at least one injection and residual air exit ports.
b) Injecting a concrete material into the said casing through the said injection port and allowing the residual air to exit through the said residual air exit ports
c) Allowing the concrete material to set, the said casing and structural reinforcements forming an integral part of the said mirror.
d) The concave curvature of the said casing with the set concrete material is smoothed and then a thin reflective film is attached thereto with an adhesive.
e) Providing a support to the said solar mirror by forming one or a plurality of trusses along the axis or transversely of the said solar mirror and preferably integral to the said solar mirror.
f) Providing a receiver along the focal line of the said solar mirror.
g) Providing a tracking system to focus a large area of sunlight onto a small area.

5) The process as claimed in claim 4, wherein the said casing comprise of casing top, casing bottom, casing sides and structural reinforcements.

6) The process as claimed in claim 4, wherein the said concrete material comprise of fiber reinforced concrete (FRC), glass fiber reinforced concrete (GFRC) or a combination thereof.

7) The process as claimed in claim 4, wherein the said adhesive is to comprise of epoxy or other adhesive.

8) The process as claimed in claim 4, wherein the said receiver comprises of photovoltaic cells with a cooling mechanism or thermal collectors.

9) The process as claimed in claim 4, wherein the said solar mirror comprise of trough, dish or fresnel type

10) The process as claimed in claim 4, wherein the said solar mirror shape comprise of parabolic, circular or the like.

11) The process as claimed in claim 4, wherein the said solar mirror have said structural reinforcements positioned longitudinally or transversely

12) The process as claimed in claim 4, wherein the said solar mirror have said structural reinforcements made of plastic, fiber reinforced plastic, metal or graphite

13) The process as claimed in claim 4, wherein the said process can be used for batch or bulk manufacturing of solar mirrors.

14) The process as claimed in claim 4, wherein the concrete material is allowed to set along with structural reinforcements, thereafter removing the said casing around it.

15) The solar mirror made according to the process as claimed in claim 9, wherein a plurality of the said solar mirror when assembled contiguously in a desired area has application as fixed roof or wall of commercial buildings, structures, tanks and houses, the said mirror when installed horizontally will have a small slope to facilitate drainage of rain water or for any washing liquid or water applied.

16) The solar mirror as claimed in claim 15, wherein the said dish solar mirror when assembled horizontally as roof of commercial buildings, structures, tanks and houses, the said dish will have a drain hole to facilitate drainage of rain water or for any washing liquid or water applied.
